(19) United States
(12) Patent Application Publication
(10) Pub. No.: US 2019/0080340 A1
(43) Pub. Date: Mar. 14, 2019

(54) Predictive Session Analyzer for a Network System

(71) Applicant: Uber Technologies, Inc., San Francisco, CA (US)

(72) Inventors: Aaron Berger, San Francisco, CA (US); Ross Williams, San Francisco, CA (US); Elizabeth Ha, Oakland, CA (US); Michael Hu, San Francisco, CA (US); Cristina Valerio, San Francisco, CA (US); Nuri Kim, San Francisco, CA (US); Alvin J. Yi, San Francisco, CA (US)

(21) Appl. No.: 16/131,339

(22) Filed: Sep. 14, 2018

Related U.S. Application Data
(60) Provisional application No. 62/558,794, filed on Sep. 14, 2017.

(51) Int. Cl. G06Q 30/02

(52) U.S. Cl. CPC G06Q 30/0202; G06Q 30/0205

(57) ABSTRACT

A travel coordination system uses historical data describing a geographic region over a set of time periods to predict the value a provider might receive for providing services within the geographic region during the set of time periods. The travel coordination system assigns a potential value score to each predicted value, and presents the potential value scores to providers via a user interface. Potential value scores are presented in a bar graph format, regional heat map, or any other interface used to present projected compensation to a provider. The travel coordination system may present previous services rendered by the provider so the provider might analyze the previous services to estimate compensation for future services. By generating potential value scores for geographic regions over various time periods, the travel coordination system makes potential compensation to providers more explicit, encouraging providers to modify their behavior in desirable ways to increase their compensation.

### CROSS REFERENCE TO RELATED APPLICATIONS

This application claims the benefit of U.S. Provisional Application No. 62/558,794, filed Sep. 14, 2017, which is incorporated by reference in its entirety.

### BACKGROUND

Travel coordination systems provide a means of travel service by connecting people who request travel service (i.e., “service requester”) with travel service providers (i.e., “providers”). A service requester can submit a request for a ride through the travel coordination system and the travel coordination system selects a provider to service the request by transporting the service requester to their requested destination.

Travel coordination systems can allow providers to decide when to start receiving service requests by going online (e.g., launching a provider application or providing input on the provider application to indicate that the provider wants to receive requests) and when to stop receiving service requests by going offline. However, providers may not be aware of the optimal time periods to be online. For example, providers may be unaware of exactly when rush hour starts and ends or may be unsure of what provider demand will be like during a holiday. Additionally, providers may be unaware of how many other providers will be available to service requests, and so may be online at a time when more providers are online than necessary for the available service requests.

### SUMMARY

Embodiments relate to generating potential values scores for providers within a travel coordination system. The travel coordination system accesses data describing a geographic region during a set of time periods. The accessed data is used to generate a set of potential value scores, where each potential value score represents a potential value to a provider for being online within the geographic region during a time period of the set of time periods. User interface data is generated that includes the set of potential value scores, where the user interface data illustrates the set of potential value scores corresponding to the set of time periods. The user interface data is transmitted to a provider device associated with the provider for presentation to the provider.

### BRIEF DESCRIPTION OF THE DRAWINGS

FIG. 1 is a high-level block diagram of a system environment and architecture for a travel coordination system, according to one embodiment.

FIG. 2 is an example user interface displaying potential value scores, according to one embodiment.

FIG. 3 is an example user interface displaying potential value scores and an event window, according to one embodiment.

FIG. 4 is an example user interface displaying potential value scores and an event window, according to one embodiment.

FIG. 5 is an example user interface displaying a heat map, according to one embodiment.

FIG. 6 is an example user interface displaying potential value scores and provider historical data, according to one embodiment.

FIG. 7 is an example user interface displaying potential value scores, provider historical data, and annotated suggestion, according to one embodiment.

FIG. 8 is a high-level block diagram illustrating a computer suitable for use in the travel coordination system, according to one embodiment.

FIG. 9 is a flow-chart illustrating a method for generating and displaying potential value scores, according to one embodiment.

### DETAILED DESCRIPTION

The Figures and the following description describe certain embodiments by way of illustration only. Although the following figures are explained with reference to generating potential value scores for providing services to service requesters, one of skill in the art will recognize that the principles are applicable in any scenario where there is a significant uncertainty of value a provider might receive for providing various services. One skilled in the art will readily recognize from the following description that alternative embodiments of the structures and methods may be employed without departing from the principles described. Wherever practicable, similar or like reference numbers are used in the figures to indicate similar or like functionality.

A travel coordination system provides services to providers and service requesters. The service requesters request a service (e.g., a travel service) from a pickup location to a destination, and the providers fulfill the requested service. The travel coordination system effectively pairs providers and service requesters, such that providers are compensated with a particular value (e.g., derived income) for providing the requested services to service requesters. However, this particular value may be inconsistent across consecutive days or weeks as the number of service requesters is subject to various environmental factors (e.g., weather, time of day, special events, public transportation closures, and the like). This inconsistency can be discouraging to providers as it may obfuscate time periods throughout a given day when peak compensation might become available, as well as which geographic regions may yield the highest number of service requesters (i.e., resulting in higher compensation).

To compensate for this inconsistency, the travel coordination system uses historical data describing a given geographic region over a set of time periods to predict the value that a provider might receive for providing a service within the geographic area during a time period of the set of time periods. The travel coordination system assigns a score to each predicted value, or a “potential value score,” and presents the potential value scores to providers via an intuitive user interface (UI). For example, potential value scores may be presented to a provider in the form of a bar graph, regional heat map, or any other interface used to quickly and easily present projected compensation to a provider. In addition, the travel coordination system may present a summary of services previously rendered by the provider in conjunction with information about average earnings of providers in similar time periods and/or geographic regions. This may assist the provider in analyzing previous services in order to optimize behavior and earn more compensation in future services (e.g., servicing different geographic regions and/or different time periods). By presenting potential value scores to the provider via a user interface, the travel coordination system gives the provider additional insight into potential future earnings, thus encouraging the provider to provide a greater number of services.

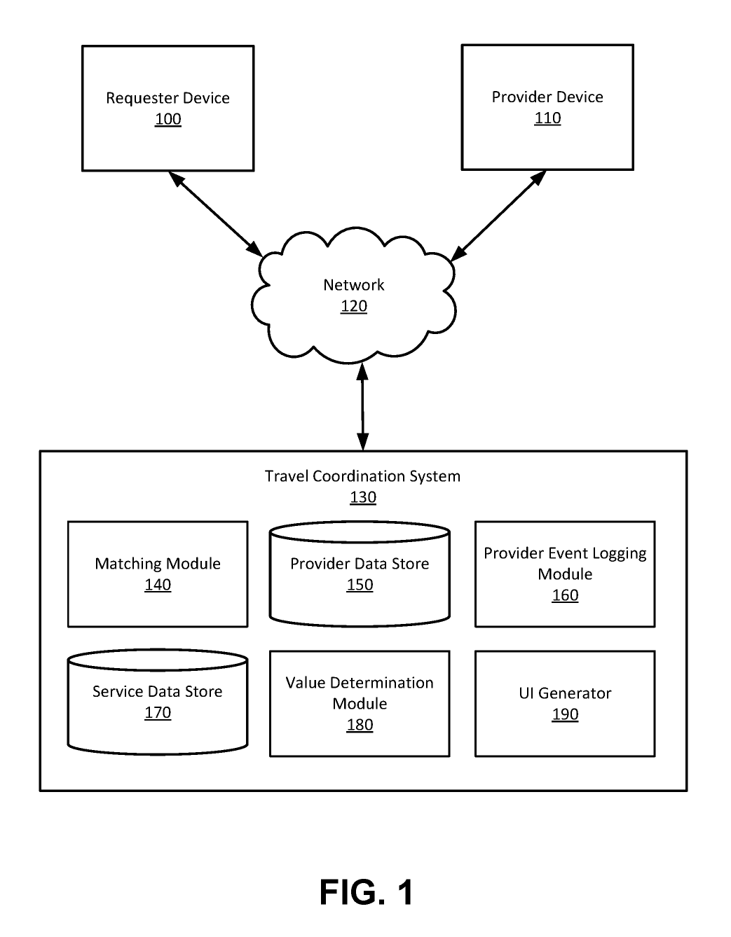

FIG. 1 illustrates a system environment and architecture for a travel coordination system 130, in accordance with some embodiments. In the embodiment illustrated in FIG. 1, the system environment includes a requester device 100, a provider device 110, a network 120, and a travel coordination system 130. Alternate embodiments may include more, fewer, or different components from those illustrated in FIG. 1, and the functionality of each component may be divided between the components differently from the description below. Additionally, each component may perform their respective functionalities in response to a request from a human, or automatically without human intervention.

By using the requester device 100, the service requester can interact with the travel coordination system 130 to request a travel service from a current location (or specified start location) to a destination location. While examples described herein relate to a travel service, the travel coordination system 130 can enable other services to be requested by requesters, such as a delivery service, food service, entertainment service, etc., in which a provider is designated to travel to a particular location, or geographic region. A service requester can make a service request to the travel coordination system 130 to request a service by operating the requester device 100. As described herein, a requester device 100 and/or a provider device 110 can be a personal or mobile computing device, such as a smartphone, a tablet, or a computer. In some embodiments, the personal computing device executes a client application that uses an application programming interface (API) to communicate with the travel coordination system 130 through the network(s) 120. In some embodiments, a service request contains service requester identification information, the number of passengers for the service, a requested type of provider (e.g., a vehicle type or service option identifier), the current location or start location (e.g., a user-specific location, or a current location of the requester determined using a geo-aware resource of the requester device 100), or the destination for the service.

The provider can use the provider device 110 to interact with the travel coordination system 130 to connect with service requesters to whom the provider can provide travel service. In some embodiments, the provider is a person driving a car, bicycle, bus, truck, boat, or other motorized vehicle capable of transporting passengers. In some embodiments, the provider is an autonomous vehicle that receives routing instructions from the travel coordination system 130. For convenience, this disclosure generally uses a car with a driver as an example provider. However, the embodiments described herein may be adapted for alternative service providers.

A provider device 110 receives, from the travel coordination system 130, assignment requests to be assigned to transport a service requester who submitted a service request to the travel coordination system 130. For example, the travel coordination system 130 can receive a service request from a requester device 100, select a provider from a pool of available, or “open,” providers to provide the service, and transmit an invitation message, or an “assignment request,” to the provider device 110 of the selected provider. In some embodiments, a provider can opt to start receiving assignment requests by going online (e.g., launching a client application on the provider device 110 and/or providing input on the client application to indicate that the provider wants to receive assignment requests). Conversely, the provider may stop receiving assignment requests by going offline (e.g., closing the client application on the provider device 110 and/or signaling to the client application that the provider is no longer receiving assignment requests). In some embodiments, when a provider device 110 receives an assignment request, the provider has the option of accepting or rejecting the assignment request. By accepting the assignment request, the provider is assigned to the service requester, and is provided the requester's start location and service destination. In one example, the requester's start location and/or destination location is provided to the provider device 110 as part of the invitation or assignment request.

In some embodiments, the provider device 110 interacts with the travel coordination system 130 through a designated client application configured to interact with the travel coordination system 130. The client application of the provider device 110 can present information, received from the travel coordination system 130, on a UI, such as a map of the geographic region, the current location of the provider device 110, an assignment request, the start location for a service requester, a route from a pickup location to a destination, current traffic conditions, and/or the estimated duration of the service, for example. The client application of the provider device 110 also can present an option for the provider to go online or offline (i.e., accept assignment requests or deny assignment requests, respectively). According to some examples, each of the requester device 100 and the provider device 110 can include a geo-aware resource, such as a global positioning system (GPS) receiver, that can determine the current location of the respective device (e.g., a GPS point). Each client application running on the requester device 100 and the provider device 110 can determine the current location of the requester or provider respectively and provide the current location to the travel coordination system 130.

The provider device 110 can receive potential value scores from the travel coordination system 130 and present the potential value scores to the provider via the UI displayed on the provider device 110. Each potential value score describes the potential value, or expected compensation to the provider, for being online at certain time periods. For example, potential value scores can describe the potential value to the provider for being online (e.g., available to provide travel services) at different times throughout a day or on different days throughout a week. The potential value can represent, but is not limited to, an estimated profit for the provider if the provider is online during the time period within a given geographic region, an estimated difference between the supply of providers and the demand for providers during the time period, or a combination thereof.

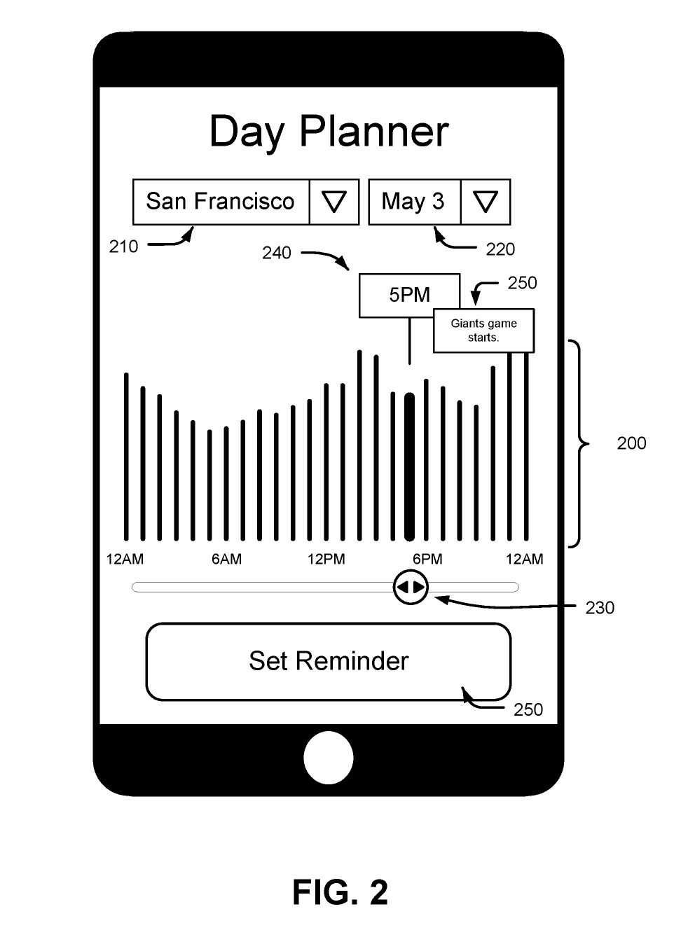

The provider device 110 can present potential value scores to the provider via a UI of a client application executing on a provider device 110. In one embodiment, the provider device 110 presents the potential value scores to the provider in the form of a bar graph, where the length of each bar represents a potential value corresponding to a given time period of a set of time periods. For example, if a bar within the bar graph corresponding to 11 am is longer than a bar corresponding to 1 pm (i.e., higher potential value score), a provider may opt to go online at 11 am rather than 1 pm given the higher potential value score for the earlier time period. In another embodiment, each potential value score is associated with contextual information describing one or more events that contributed to the overall potential value score. For example, if a weather event, such as a thunder storm, is predicted to occur within a given geographic region during a certain time period, the potential value score associated with that geographic region may increase given the increased demand for providers from service requesters. This contextual information may be presented in the UI within an annotated event window. The provider device 110 can also present an interface through which a provider can set a reminder to go online for a specified time period based on the potential value score corresponding to the time period. Additional information regarding the UI of the client application on the provider device 110 is described with respect to FIGS. 2-7 in the following sections.

The requester device 100 and provider device 110 communicate with the travel coordination system 130 via the network 120, which may comprise any combination of local area and wide area networks employing wired or wireless communication links. In one embodiment, the network 120 uses standard communications technologies and protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any format, such as hypertext markup language (HTML) or extensible markup language (XML). In some embodiments, all or some of the communication links of the network 120 may be encrypted.

FIG. 1 also illustrates an example system architecture of the travel coordination system 130, in accordance with some embodiments. The travel coordination system 130 illustrated in FIG. 1 includes a matching module 140, a provider data store 150, a provider event logging module 160, a service data store 170, a value determination module 180, and a UI generator 190. Alternate embodiments may include more, fewer, or different components from those illustrated in FIG. 1, and the functionality of each component may be divided between the components differently from the description below. Additionally, each component may perform their respective functionalities in response to a request from a human, or automatically without human intervention.

The matching module 140 selects a provider to service the request of a service requester. The matching module 140 receives a service request from a service requester through the requester device 100 and determines a set of candidate providers that are online, open (i.e., are available to service a requester), and near the requested start location for the requester. The matching module 140 selects a provider from the set of candidate providers to which it transmits an assignment request. The provider can be selected based on the provider's location, the requester's pickup location, the type of the provider, the amount of time the provider has been waiting for an assignment request and/or the destination of the service, among other factors. In some embodiments, the matching module 140 selects the provider who is closest to the start location or would take the least amount of time to travel to the start location. The matching module 140 sends an assignment request to the selected provider. In some embodiments, the provider device 110 always accepts the assignment request and the provider is assigned to the requester. In some embodiments, the matching module 140 awaits a response from the provider device 110 indicating whether the provider accepts the assignment request. If the provider accepts the assignment request, then the matching module 140 assigns the provider to the service requester. If the provider rejects the assignment request, then the matching module 140 selects a new provider and sends an assignment request to the provider device 110 for that provider. In some embodiments, rather than requesting confirmation from the provider device 110, the travel coordination system 130 assigns the selected provider to the service requester without express confirmation from the provider device 110.

The provider data store 150 stores information about providers (e.g., state or status information of providers or associated client applications). For example, the provider data store 150 can store whether the provider is online or offline, whether the provider is open or has been assigned to a service requester, the current location of the provider via the provider device 110, and the number of passengers a provider can transport. In some embodiments, the provider data store 150 determines and stores information about a provider's historical information through the client application, such as when the provider tends to be online/offline, where the provider tends to be available for service, and how likely the driver is to go online when the potential value for a particular time period is high. In one embodiment, the provider data store 150 stores a threshold potential value score associated with each provider, in which the threshold potential value score indicates a threshold potential value that is most likely to cause the provider to go online (e.g., begin accepting assignment requests). This allows the travel coordination system 130 to maintain a record of a number of providers that might go online given a particular potential value score corresponding to a certain geographic region for a particular time period. In some embodiments, the provider data store 150 stores a profile for each provider. For example, providers may be categorized based on the number of passengers they can transport, the type of vehicle the provider is driving, or whether the provider is driving what is considered to be a “luxury” vehicle. In some embodiments, the provider data store 150 stores provider information based on personalized preferences for each provider.

The provider event logging module 160 logs information about events relating to a provider to the provider data store 150. For example, the provider event logging module 160 may log a provider going online, going offline, being assigned to a requester or becoming open (i.e., available for receiving assignment requests). In some embodiments, the provider event logging module 160 logs the time and location of each event. In some embodiments, each logged event is associated with a provider profile in the provider data store 150.

The service data store 170 stores information about services provided through the travel coordination system 130. For example, the service data store 170 can store the start and end locations of a service, the start and end times of a service, identification information of the provider or service requester, the duration and distance of a service, a value acquired by the provider for rendering the service, the number of requested passengers using the service, the time at which the requester requested the service, or the route taken by the provider. In some embodiments, the service data store 170 associates each service with a provider profile in the provider data store 150 for the provider associated with the service.

The value determination module 180 determines a potential value that a provider might expect to receive for being online within a particular geographic region during a given time period from a set of time periods. For example, the value determination module 180 may determine the potential value to a provider of being online within a geographic area during each hour of a day or during each day of a week. In some embodiments, the value determination module 180 determines a potential value score for each geographic region and time period. A higher potential value score can represent a greater compensation value (e.g., derived income) to the provider for being online within a geographic region during a particular period of time. Conversely, a lower potential value score can represent a decreased compensation value to the provider for providing services. The value determination module 180 may use a variety of criteria, and in various combinations, to determine potential value scores. For example, the value determination module 180 may use historical data associated with a previous demand for providers within a geographic region (e.g., provider demand during rush hour downtown the previous day) and generate a new potential value score based on this previous demand. The value determination module may also ingest real-time data pertaining to traffic, special events, and/or weather for a given geographic region to make more nuanced predictions. Additionally, the value determination module 180 can use both historical data and real-time data collectively to generate a potential value score. For example, given that provider demand tends to increase during rush hour, this demand might be greater if a rain storm is predicted in the forecast, when the weather is less conducive for traveling by foot than that of previous days within the geographic region during the given time period.

In one embodiment, the value determination module 180 can determine the potential value score associated with a geographic region during a time period based on a predicted supply and/or a predicted demand for providers within the geographic region during the time period. The predicted provider supply may describe the predicted number of providers who will be available for providing service to service requesters within the geographic region during the time period; the predicted provider demand may describe the predicted number of service requesters who will request service within geographic region during the time period. The value determination module 180 may determine the provider supply based on historical provider supply data (e.g., stored in the provider data store 150) that describes the provider supply or factors related to provider supply in past time periods. For example, the historical provider supply data may describe when providers were online, the rate at which providers went online or offline, and the rate at which providers finished services. The value determination module 180 also may determine the provider demand based on historical provider demand data (e.g., stored in the service data store 170) that describes the provider demand or factors related to provider demand in past time periods. For example, the historical provider demand data may describe the rate at which the travel coordination system 130 received service requests, the rate at which the travel coordination system 130 transmitted assignment requests to providers, or the number of service requesters that were using a client application on the requester device 100. In one embodiment, the value determination module 180 determines the potential value score corresponding to a geographic region during a time period based on a difference between the predicted provider demand and the predicted provider supply. For example, the value determination module 180 may determine a high potential value score for a geographic region during a time period if the predicted provider demand is high and the predicted provider supply is low. In contrast, the value determination module 180 may determine a low potential value score for a geographic region during a time period if the predicted provider demand is low and the predicted provider supply is high.

In one embodiment, the demand prediction module 510 generates a potential value score using a historical provider demand associated with similar time periods. Time periods are considered similar if the statistical variation in provider demand for several such periods is below a given threshold. For example, if the average provider demand on any weekday between 4:00 PM and 5:00 PM is relatively high, all weekdays between those times might be considered similar (i.e., within a threshold of one another). However, if a statistical change in provider demand is noted between those times on a Friday relative to other weekdays, then Fridays would not be considered similar to other weekdays (i.e., outside of the given threshold). Factors that can influence periodic provider demand for any given geographic region include: day, time, month, season, proximity to public holidays, other regular events (e.g., Superbowl weekend), etc. Non-periodic events can also influence provider demand. For example, if a transit service is shut down for scheduled maintenance, the value determination module 180 might receive a notification in advance from an external data source (e.g., a scheduled maintenance feed provided by the transit company via the Internet). The effect of that maintenance can then be estimated from previous potential value scores where the transit service was unavailable within that particular geographic region. As another example, if the pickup location is near a sports stadium, the value determination module 180 might monitor a feed of the current score and time remaining in games at the stadium. The effect of different scores at different times in a game can then be correlated with provider demand (e.g., provider demand is low before the end of a tight game because everyone wants to stay, but higher if the game is a blow-out as many fans leave early to try and beat the rush). In this way, the value determination module 180 can adjust a given potential value score based on real-time environmental factors.

In one embodiment, the value determination module 180 employs a machine learning model to improve predictions for potential value scores over time. After any given time period within a geographic region, the predicted potential value (e.g., potential value score) for that geographic region during that period is compared to the actual compensated value (e.g., derived income). The difference between the predicted potential value and actual compensated value is an error margin that is fed back into the model. If the predicted potential value is less than the actual compensated value, the model is adjusted such that future predictions of potential value for similar geographic regions over similar time periods are larger. Conversely, if the predicted potential value exceeded the actual compensated value, future predictions will be lower. Thus, the model is improved over time to more accurately predict the true potential value. The model can also respond dynamically to changes in provider demand pattern.

In other embodiments, potential value scores for future services are predicted using a machine learning model that examines patterns of historical earnings within a given geographic region. For example, the machine learning model can forecast value that a provider might receive based on a linear model of earnings providers have previously earned within the region over a 24 hour range spanning the previous day, 7 days ago, 14 days ago, etc. Based on earnings generated throughout this time frame, the machine learning model can identify patterns used to influence future potential value scores within the region.

In other embodiments, the machine learning model predicts potential value scores using several signals as inputs. Each input signal is weighted and processed by the machine learning model to produce a predicted potential value score as output. The weight given to each signal is evolved over time based on the accuracy of the predictions. Thus, the prediction becomes more reliable over time, increasing the efficiency of the travel coordination system 130.

In some such embodiments, the input signals might include the geographic region, month, day of the week, time of day (e.g., to the nearest hour, half-hour, quarter-hour, minute, or the like), proximity to holidays, proximity to scheduled events (e.g., sporting events, conventions, public transit maintenance, etc.), and the number of service requesters within the geographic region. Initially, the model assigns greatest weight to signals that have known historical correlations (e.g., month, day, time, etc.) with potential value scores. However, over time the weight given to signals with more direct but less well known correlations to potential value score (e.g., sporting events, public transportation maintenance) might increase as the model learns the corresponding correlations. Thus, the predicted potential value scores can become more accurate over time as more data is collected and processed.

In some embodiments, the value determination module 180 determines the potential value score of a geographic region during a time period based on reminders established by providers to go online (i.e., become available to provide travel services to service requesters) during a time period. A provider may use the provider device 110 to establish reminders to go online during a specified time period of a set of available time periods. In some embodiments, the provider may use the client application operating on the provider device 110 to establish the reminder (e.g., via a UI). The provider device 110 notifies the provider of the established reminder shortly before or at the beginning of the associated time period. The value determination module 180 can use the reminders to determine the potential value of a geographic region during a time period by using the reminders to estimate the number of providers that will go online within the geographic region during the time period. The value determination module 180 can approximate that all providers with a reminder will go online or that only a portion of the providers will go online. In some embodiments, the value determination module 180 determines, for each provider with a reminder, the likelihood of whether the provider will go online during the time period. The value determination module 180 may determine the likelihood based on the provider's history of going online in response to reminders. In particular, the value determination module 180 can identify a threshold potential value score associated with each provider (stored in the provider data store 150) to determine the likelihood, where the threshold potential value score indicates a threshold potential value that is most likely to cause the provider to go online (e.g., begin accepting assignment requests). The value determination module 180 can then use the determined likelihoods to generate a potential value score for the geographic region during the time period that accounts for the number of providers who will go online during the time period, as well as those providers that will likely not go online during the time period.

In one embodiment, the value determination module 180 uses a provider's preferences to determine the potential value of a time period. The provider may use the provider device 110 to input preferences into the client application that outline where, when, and how the provider wants to provide service to service requesters. For example, the provider may indicate preferences such as time periods during which the provider prefers to be online for requests, a preferred geographic region for start or end destinations, a preferred number of passengers requested to service at a time, or preferred lengths of service.

In one embodiment, the value determination module 180 uses the provider's behavior to determine the potential value score of a geographic region during a time period. For example, the value determination module 180 may use where or when a provider tends to drive or go online to determine the potential value of a time period for the provider. In some embodiments, the value determination module 180 determines the potential value of a time period for a provider based on whether the provider goes online during time periods with high potential value. For example, the value determination module 180 may increase or decrease a potential value to further encourage (or discourage) the provider to go online.

The UI generator 190 generates UI data to be displayed on a provider device 110 for presenting potential value scores to a provider in various formats. In one embodiment, the UI generator 190 receives potential value scores from the value determination module 180, and generates a UI that presents a bar graph representation of the potential value scores, in which the length of each bar in the bar graph corresponds to a potential value score for a particular time period. In another embodiment, the UI generator 190 generates a UI displaying a map of a given geographic region, in which potential value scores are depicted similarly to a heat map, where areas with relatively higher potential value scores are represented as warmer areas within the map (e.g., white, red, and/or yellow). Similarly, areas within the map having relatively lower potential value scores are represented as cooler areas (e.g., green, cyan, and/or blue). In yet another embodiment, the UI generator 190 generates a UI that includes potential value scores from a previous set of time periods (e.g., yesterday, last week, two weeks ago, etc.) in addition to the routes a provider previously took while completing service requests during the set of time periods. In this embodiment, the provider is able to discern where and when peak potential value scores occurred in relation to the previous routes and times to learn how to maximize compensation for providing future services during optimal time periods. These embodiments are discussed in greater detail below.

FIG. 2 illustrates an example user interface (UI) displaying potential value scores 200 to a provider, according to one embodiment. In the embodiment illustrated in FIG. 2, the UI represents the potential value scores 200 as a bar graph, where each bar in the bar graph corresponds to a potential value score for an hour-long time period within a set of time periods spanning 24 hours. Alternate example UIs can show potential value scores for different sets of time periods, such as periods within the 24 hours of consecutive dates, time periods within business hours of a single date, or time periods within a set of days. The length of a bar in the bar graph represents the magnitude of the potential value score 200 (e.g., a longer bar in the bar graph represents a higher potential value score). The example UI includes options for the provider to select a geographic region 210, a date 220, and/or time period for which the provider would like to view potential value scores 200. Thus, if the provider would like to view potential value scores corresponding to a set of time periods within a different geographic region, and/or a set of time periods for a different date altogether, the provider may specify these preferences using the dropdown geographic region 210 and date 220 fields, respectively.

The example UI illustrated in FIG. 2 also allows the provider to establish a reminder to go online during one of the displayed time periods. In the embodiment illustrated in FIG. 2, the provider can use a time period selection slider 230 to select a time period 240 during which the provider would like to be reminded to go online by the travel coordination system 130. The provider can then select the reminder button 250 to set the reminder for the selected time period. In other embodiments, the reminder button 250 may also be used by a provider to specify a minimum potential value score, or a threshold of minimum predicted earnings, such that generated potential value scores exceeding the minimum potential value score may notify the provider to go online. Additionally, the reminder button 250 may include various options that allow the provider to perform additional functionality using the time period specified by the time period selection slider 230. For example, the provider may wish to view additional details corresponding to the selected time period, such as contextual information that might have contributed to the potential value score, the magnitude of the potential value score in previous weeks at a glance, or any other information associated with the selected potential value score that may prove useful to the provider.

In addition, the example UI illustrated in FIG. 2 includes an annotated event window 250 that provides contextual information for the potential value score 200 that corresponds to the selected time period 240, if any such events attribute to the overall potential value score. In the example illustrated in FIG. 2, the potential value score 200 corresponding to the time period 240 (e.g., 5 pm) is at least partially attributed to an event occurring within the geographic location (e.g., beginning of a Giants baseball game). In this way, the UI presents real-time data to inform the provider of events occurring in the geographic region that may be of interest to the provider in terms of generating service requesters, or geographic regions to avoid due to increased traffic in the region due to the event.

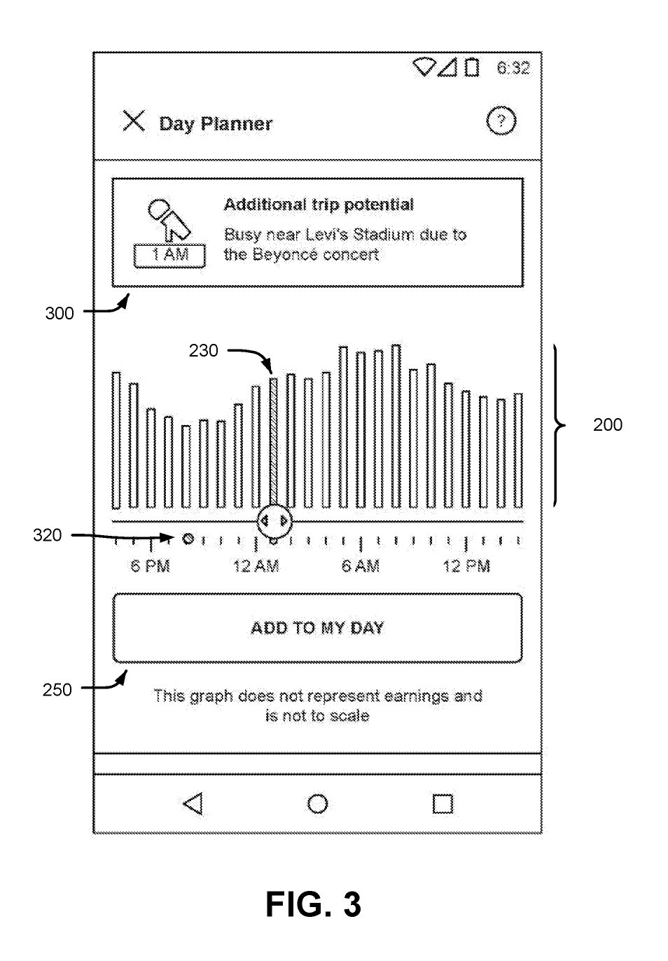

FIG. 3 illustrates an example UI presenting potential value scores to a provider on a provider device 110, according to one embodiment. In the embodiment illustrated in FIG. 3, the potential value scores 200 for a given geographic region within a set of time periods spanning 24 hours (i.e., 4 pm to 3 pm the following day) is displayed. Similar to the bar graph illustrated in FIG. 2, the length of each bar in the bar graph corresponds to a magnitude of the potential value score corresponding to each time period within the set of time periods. The current time 320 is displayed as a dot within the set of time periods, as well as the potential value score corresponding to the current time 320. In addition, the UI displays an annotated event window 300 that presents real-time data to the provider via the provider device 110. In the example illustrated in FIG. 3, the annotated event window 300 displays that a Beyoncé concert will most likely be over around 1 am that morning, and might result in increased traffic and/or service requesters near Levi's Stadium. This is represented in the figure as the potential value scores preceding 1 am start to become higher (i.e., taller bars in bar graph) and continue to grow steadily until around 6 am. In this example, the provider may specify this time period to provide service, and receive a reminder from the travel coordination system 130 by sliding the time period selection slider 230 to 1 am and selecting the reminder button 250.

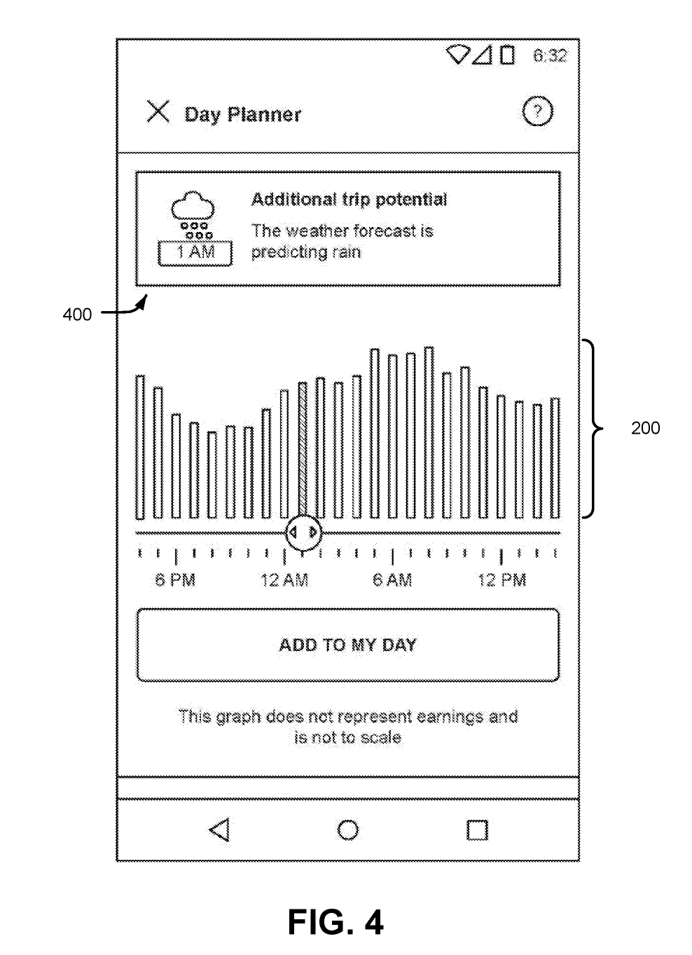

FIG. 4 illustrates an example UI presenting potential value scores to a provider on a provider device 110, according to one embodiment. In the embodiment illustrated in FIG. 4, the UI includes an annotated event window 400 that presents real-time data to a provider describing a weather event. In this example, the annotated event window 400 informs the provider of predicted rain around 1 am within the given geographic region. In one embodiment, the predicted weather event may originate from an external data source (e.g., live weather feed) and be provided to the UI via the travel coordination system 130. In other embodiments, events displayed in the annotated event window 400 may be generated by the travel coordination system 130.

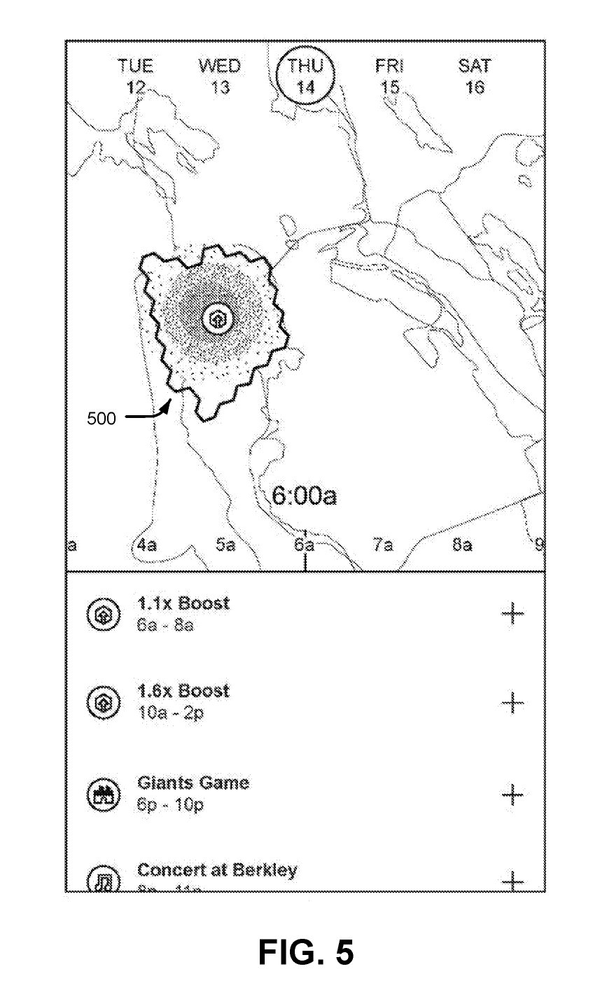

FIG. 5 illustrates an example UI presenting potential value scores to a provider on a provider device 110 in the form of a heat map, according to one embodiment. Providing potential value scores in a heat map may enable greater granularity in the presentation of value scores. For example, different value scores may be represented for each neighborhood in a city, each city block, or any other sub-division of a region (e.g., a city may be divided up into one square mile blocks, etc.). In one embodiment, the UI generator 190 represents zones for which the potential value scores are relatively high as “warmer” areas within the heat map (e.g., white, red, and/or yellow). Conversely, the UI generator 190 represents zones with relatively low potential value scores as “cooler” areas in the heat map (e.g., green, cyan, and/or blue). Due to the increased granularity that is presented in a heat map, it becomes more likely that a provider will provide a travel service having a route that spans multiple adjacent zones or travel to a neighboring zone to pick up a service requester. Therefore, the value determination module 180 may determine an overall potential value score comprised of a weighted combination of potential value scores for the zone in question and one or more nearby (e.g., adjacent) zones.

In the embodiment shown in FIG. 5, “warm” areas of the heat map 500 are represented using dense clusters of dots representing service requesters and “cool” areas of the heat map 500 are represented using sparse clusters of dots for illustrative purposes. In other embodiments, different visual indicators are used to indicate the relative potential value scores of different geographic regions. In response to receiving the heat map 500 on a provider device 110, a provider may wish to service the zones with higher potential value scores (e.g., densely populated areas) in order to maximize compensation for providing services. Therefore, the UI influences ways in which a provider decides to provide services.

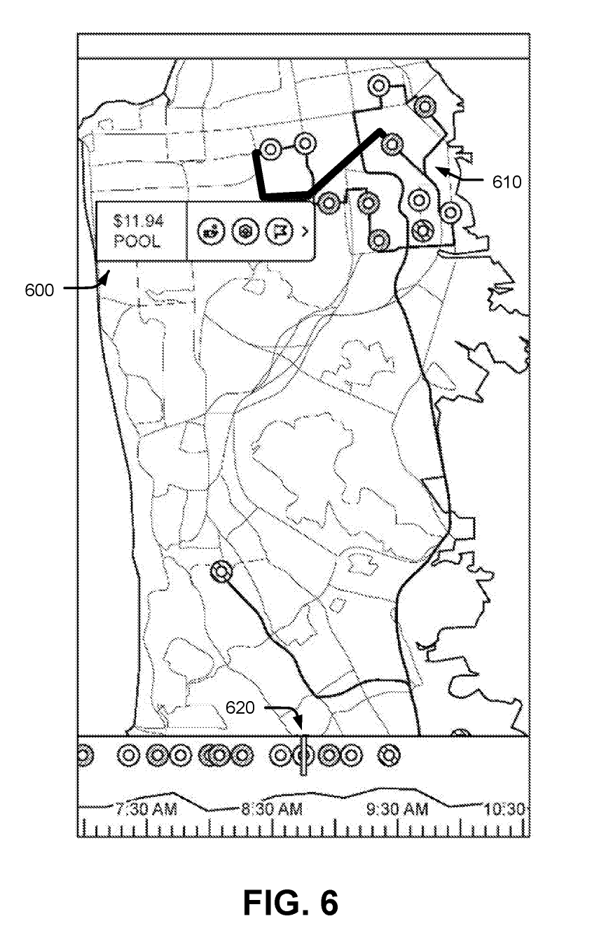

FIG. 6 illustrates an example UI presenting historical data to a provider on a provider device 110, according to one embodiment. In the embodiment illustrated in FIG. 6, historical data including previous routes 610 taken by a provider while completing a series of travel services for several service requesters is shown in the UI. In addition, the UI displays a timeline including time periods spanning several hours (e.g., 7 am to 10:30 am), as well as the potential value scores corresponding to each time period. In this embodiment, the potential value scores are displayed as a line graph indicating a magnitude of each potential value score above its corresponding time period. Displayed above the potential value line graph are several circles indicating start times and stop times corresponding to each of the previous routes 610 displayed in the UI.

In the embodiment illustrated in FIG. 6, a provider is able to slide the time period selection slider 620 to select a start time and/or stop time from each respective previous route 610 available on the timeline. When the provider selects a start time or stop time corresponding to a previous route 610 (or the space between respective start and stop times belonging to a trip), the UI highlights, or otherwise indicates, the previous route 610 to which the start and stop times belong. Similarly, when the provider selects a start location and/or destination belonging to a previous route 610, the UI positions the time period selection slider 620 over its corresponding time period. In the example illustrated in FIG. 6, the provider has selected a stop time corresponding to a “pool” service in which several service requesters were provided travel service at once (e.g., a car pool). This is shown in the annotated historical context window 600 displayed in the UI providing historical context for the previous route showing a pool service amounting to $11.94 in compensation. Viewing historical data in this way allows a provider to identify when and where the provider was servicing requests during optimal time periods in order to garner more compensation for future services, perhaps by servicing different geographic regions during different time periods, for example.

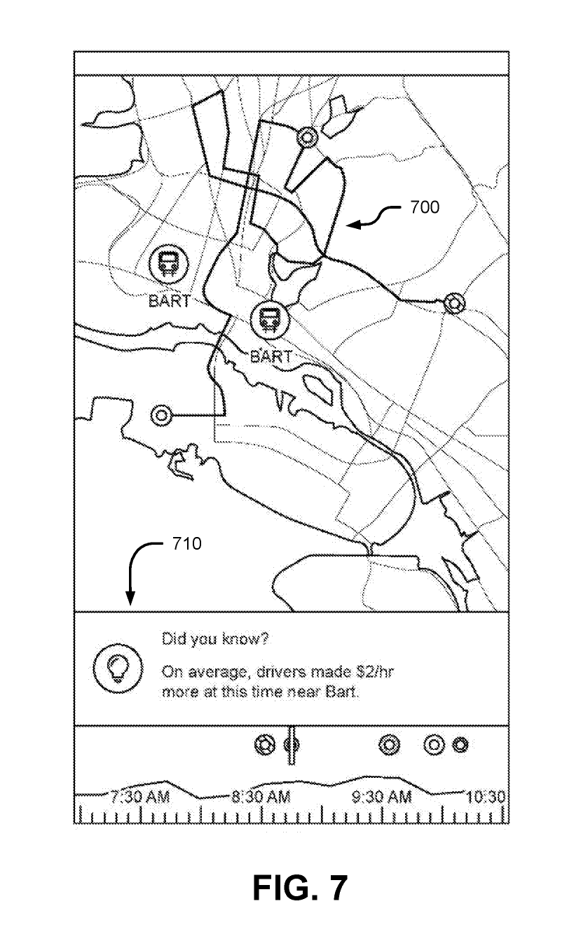

FIG. 7 illustrates an example UI presenting historical data to a provider on a provider device 110, according to one embodiment. Similar to the UI illustrated in FIG. 6, the UI shown in FIG. 7 includes previous routes 700 taken by a provider while completing a service, in addition to the timeline displaying several time periods and their corresponding potential value scores in the form of a line graph. In addition, the start points and end points comprising each instance of a travel service are included above their corresponding time periods. In the example illustrated in FIG. 7, a provider began providing a travel service around 9:30 am (as indicated by the start time shown in the timeline), and traveled south before reaching the destination around 10 am (as shown by the stop time). While providing the travel service, the provider passed between two adjacent public transportation (e.g., BART) stations. In response to identifying that the provider was near a location that typically generates comparatively high potential value scores, the UI includes an annotated historical context window 710 indicating that “drivers made $2/hr more at [the time specified on the timeline] near Bart.” In this way, the travel coordination system 130 can notify a provider of changes in behavior from previous time periods that could have resulted in increased earnings. Thus, a provider may choose to alter future routes in order to maximize compensation. In this example, the provider may select routes that include a route passing near BART stations at the time specified in the timeline for future travel services.

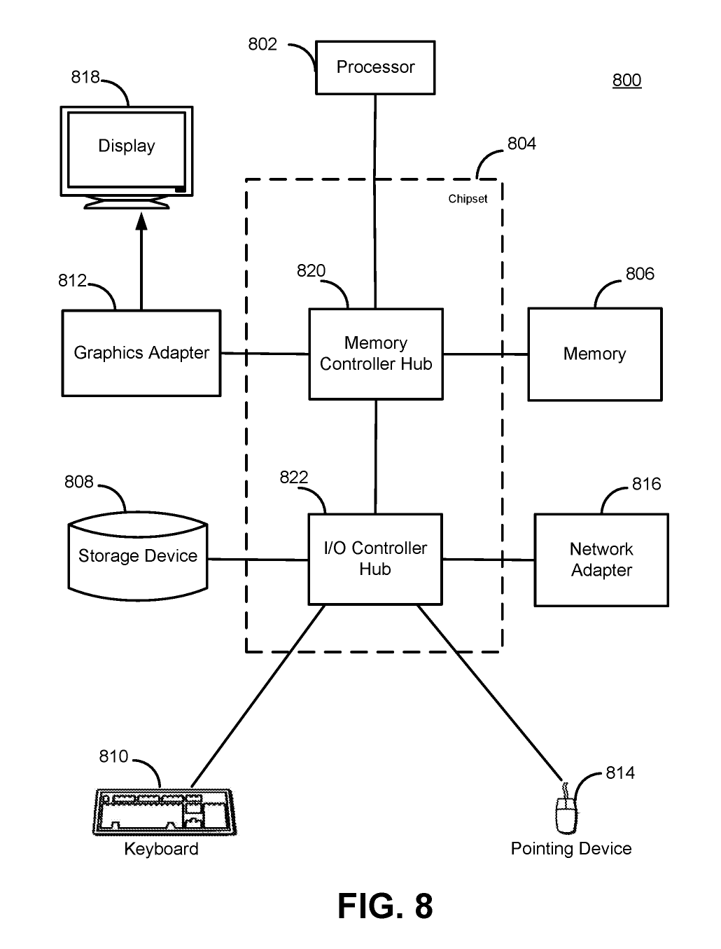

FIG. 8 is a high-level block diagram illustrating an example computer 800 suitable for use as a travel coordination system 130, according to one embodiment. The example computer 800 includes at least one processor 802 coupled to a chipset 804. The chipset 804 includes a memory controller hub 820 and an input/output (I/O) controller hub 822. A memory 806 and a graphics adapter 812 are coupled to the memory controller hub 820, and a display 818 is coupled to the graphics adapter 812. A storage device 808, keyboard 810, pointing device 814, and network adapter 816 are coupled to the I/O controller hub 822. For some devices (e.g., a mobile device used as a passenger device 220), the keyboard 810 is an on-screen keyboard and the pointing device 814 is a touch-screen. Other embodiments of the computer 700 have different architectures.

In the embodiment shown in FIG. 8, the storage device 808 is a non-transitory computer-readable storage medium such as a hard drive, compact disk read-only memory (CD-ROM), DVD, or a solid-state memory device. The memory 806 holds instructions and data used by the processor 802. The pointing device 814 is a mouse, track ball, touch-screen, or other type of pointing device, and is used in combination with the keyboard 810 to input data into the computer system 800. The graphics adapter 812 displays images and other information on the display 818. The network adapter 816 couples the computer system 800 to one or more computer networks, such as network 250.

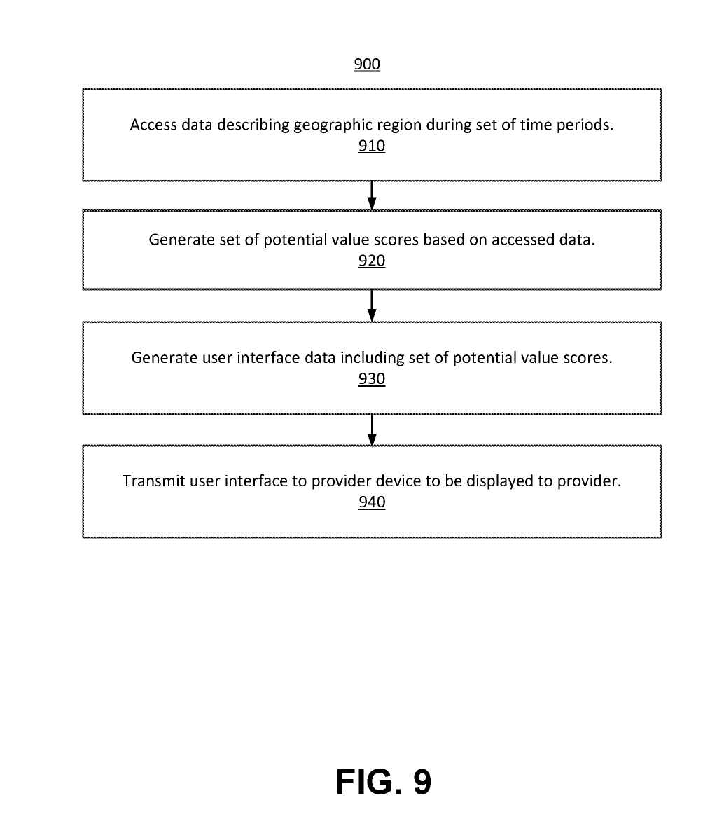

FIG. 9 is a flowchart for a method for determining the potential value of time periods, in accordance with some embodiments. Alternate embodiments may include more, fewer, or different steps from those illustrated in FIG. 9, and the steps may be performed in a different order from that illustrated in FIG. 9. Additionally, each of these steps may be performed automatically by the travel coordination system without human intervention.

The travel coordination system accesses 910 data describing a geographic region (e.g., provider supply and demand data) during a set of time periods. The geographic region can be a geographic region containing a provider to be presented with potential value scores or a geographic region near the provider. The travel coordination system can use the data describing the geographic region to generate potential value scores 920 for the set of time periods. Each potential value score represents the potential value to a provider for being online within the geographic region during a time period. In some embodiments, the potential value scores represent a difference between a predicted amount of provider demand during a time period and a predicted amount of provider supply during a time period. The travel coordination system generates 930 UI data (e.g., bar graph, heat map, historical context, etc.) including the potential value scores to present to the provider. The travel coordination system transmits 940 the UI data to a provider device associated with the provider and the provider device displays the UI data to the provider.

### ADDITIONAL CONSIDERATIONS

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some embodiments, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
accessing data describing a geographic region during a set of time periods;
generating a set of potential value scores based on the accessed data, each potential value score of the set of potential value scores representing a potential value to a provider for being online within the geographic region during a time period of the set of time periods;
generating user interface data including the set of potential value scores, the user interface data illustrating the set of potential value scores corresponding to the set of time periods; and
transmitting the user interface to a provider device associated with the provider for presentation to the provider.

2. The method of claim 1, wherein illustrating the set of potential value scores comprises:
generating a bar graph representing the set of potential value scores, each bar of the bar graph representing a potential value score of the set of potential value scores, each bar of the bar graph having a length associated with a magnitude of a potential value score of the set of potential value scores corresponding to the set of time periods.

3. The method of claim 2, wherein generating the bar graph further comprises:
identifying an event associated with a potential value score corresponding to a time period of the set of time periods;
generating an event window describing the identified event; and
including the event window proximate to a bar of the bar graph representing the potential value score corresponding to the time period of the set of time periods.

4. The method of claim 1, wherein illustrating the set of potential value scores further comprises:
receiving, from the provider, a request to generate a map of the geographic region;
generating the map of the geographic region, the generated map including a plurality of zones comprising the geographic region; and
determining, for each zone of the plurality of zones, a portion of the potential value score, the portion of the potential value score representing a potential value to the provider for being online within each zone of the plurality of zones comprising the geographic region during the set of time periods.

5. The method of claim 4, wherein generating the map of the geographic region further comprises:
generating a heat map describing each zone of the plurality of zones comprising the geographic region, the heat map indicating zones in which one or more service requesters are most likely to be located during the set of time periods.

6. The method of claim 1, wherein generating the user interface further comprises:
identifying a historical context associated with the provider, the historical context describing a correlation between a potential value previously received by the provider for being online within a geographic region during a time period of the set of time periods;
generating a historical context window describing the identified historical context; and
including the historical context window within the user interface for presentation to the provider.

7. The method of claim 1, further comprising:
receiving an established reminder from the provider device, the established reminder identifying a time period of the set of time periods during which the provider has established a preference to be online.

8. A non-transitory computer readable storage medium, storing instructions for the steps comprising:
accessing data describing a geographic region during a set of time periods;
generating a set of potential value scores based on the accessed data, each potential value score of the set of potential value scores representing a potential value to a provider for being online within the geographic region during a time period of the set of time periods;
generating user interface data including the set of potential value scores, the user interface data illustrating the set of potential value scores corresponding to the set of time periods; and
transmitting the user interface to a provider device associated with the provider for presentation to the provider.

9. The non-transitory computer readable storage medium of claim 8, wherein illustrating the set of potential value scores comprises:
generating a bar graph representing the set of potential value scores, each bar of the bar graph representing a potential value score of the set of potential value scores, each bar of the bar graph having a length associated with a magnitude of a potential value score of the set of potential value scores corresponding to the set of time periods.

10. The non-transitory computer readable storage medium of claim 9, wherein generating the bar graph further comprises:
identifying an event associated with a potential value score corresponding to a time period of the set of time periods;
generating an event window describing the identified event; and
including the event window proximate to a bar of the bar graph representing the potential value score corresponding to the time period of the set of time periods.

11. The non-transitory computer readable storage medium of claim 8, wherein illustrating the set of potential value scores further comprises:
receiving, from the provider, a request to generate a map of the geographic region;
generating the map of the geographic region, the generated map including a plurality of zones comprising the geographic region; and
determining, for each zone of the plurality of zones, a portion of the potential value score, the portion of the potential value score representing a potential value to the provider for being online within each zone of the plurality of zones comprising the geographic region during the set of time periods.

12. The non-transitory computer readable storage medium of claim 11, wherein generating the map of the geographic region further comprises:
generating a heat map describing each zone of the plurality of zones comprising the geographic region, the heat map indicating zones in which one or more service requesters are most likely to be located during the set of time periods.

13. The non-transitory computer readable storage medium of claim 8, wherein generating the user interface further comprises:
identifying a historical context associated with the provider, the historical context describing a correlation between a potential value previously received by the provider for being online within a geographic region during a time period of the set of time periods;
generating a historical context window describing the identified historical context; and
including the historical context window within the user interface for presentation to the provider.

14. The non-transitory computer readable storage medium of claim 8, further comprising:
receiving an established reminder from the provider device, the established reminder identifying a time period of the set of time periods during which the provider has established a preference to be online.

15. A computer system comprising:
one or more electronic processors; and
a non-transitory computer readable storage medium, storing instructions for the steps comprising:
accessing data describing a geographic region during a set of time periods;
generating a set of potential value scores based on the accessed data, each potential value score of the set of potential value scores representing a potential value to a provider for being online within the geographic region during a time period of the set of time periods;
generating user interface data including the set of potential value scores, the user interface data illustrating the set of potential value scores corresponding to the set of time periods; and
transmitting the user interface to a provider device associated with the provider for presentation to the provider.

16. The computer system of claim 15, wherein illustrating the set of potential value scores comprises:
generating a bar graph representing the set of potential value scores, each bar of the bar graph representing a potential value score of the set of potential value scores, each bar of the bar graph having a length associated with a magnitude of a potential value score of the set of potential value scores corresponding to the set of time periods.

17. The computer system of claim 16, wherein generating the bar graph further comprises:
identifying an event associated with a potential value score corresponding to a time period of the set of time periods;
generating an event window describing the identified event; and
including the event window proximate to a bar of the bar graph representing the potential value score corresponding to the time period of the set of time periods.

18. The computer system of claim 15, wherein illustrating the set of potential value scores further comprises:
receiving, from the provider, a request to generate a map of the geographic region;
generating the map of the geographic region, the generated map including a plurality of zones comprising the geographic region; and
determining, for each zone of the plurality of zones, a portion of the potential value score, the portion of the potential value score representing a potential value to the provider for being online within each zone of the plurality of zones comprising the geographic region during the set of time periods.

19. The computer system of claim 18, wherein generating the map of the geographic region further comprises:
generating a heat map describing each zone of the plurality of zones comprising the geographic region, the heat map indicating zones in which one or more service requesters are most likely to be located during the set of time periods.

20. The computer system of claim 15, wherein generating the user interface further comprises:
identifying a historical context associated with the provider, the historical context describing a correlation between a potential value previously received by the provider for being online within a geographic region during a time period of the set of time periods;
generating a historical context window describing the identified historical context; and
including the historical context window within the user interface for presentation to the provider.
